(19) United States
(12) Patent Application Publication
(10) Pub. No.: US 2010/0297979 A1
(43) Pub. Date: Nov. 25, 2010

(54) METHOD AND APPARATUS FOR PROCESSING EMERGENCY CALLS

(75) Inventors: Mahmoud Watfa, Saint Leonard (CA); Behrouz Aghili, Commack, NY (US); Ulises Olvera-Hernandez, Kirkland (CA); Peter S. Wang, E. Setauket, NY (US); Paul Marinier, Brossard (CA); Shankar Somasundaram, London (GB)

Correspondence Address: VOLPE AND KOENIG, P.C.;DEPT. ICC, UNITED PLAZA, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/758,463

(22) Filed: Apr. 12, 2010

Related U.S. Application Data
(60) Provisional application No. 61/168,997, filed on Apr. 14, 2009.
(60) Provisional application No. 61/183,151, filed on Jun. 2, 2009.
(60) Provisional application No. 61/185,410, filed on Jun. 9, 2009.
(60) Provisional application No. 61/220,899, filed on Jun. 26, 2009.
(60) Provisional application No. 61/236,776, filed on Aug. 25, 2009.
(60) Provisional application No. 61/259,058, filed on Nov. 6, 2009.
(60) Provisional application No. 61/260,721, filed on Nov. 12, 2009.

(51) Int. Cl. H04M 11/04

(52) U.S. Cl. 455/404.1

(57) ABSTRACT

A method and apparatus are described for processing emergency calls by simplifying call setup procedures and minimizing call setup delay. In one scenario, a system information (SI) broadcast may include emergency services support information that conveys various emergency call network support levels and setup procedures. The SI broadcast is decoded to retrieve system parameters used to process an emergency call. The SI broadcast may include a bitmap or at least one information element (IE), that indicates the various emergency call network support levels. In another scenario, an extended service request message indicating circuit switched fallback (CSFB) for an emergency call is transmitted to a packet switched (PS) radio access technology (RAT) network during a PS session. An inter-system change is performed from the PS RAT network to a circuit switched (CS) RAT without a PS handover, and a CS emergency call is initiated via the CS RAT network.

### CROSS REFERENCE TO RELATED APPLICATIONS

This application claims the benefit of U.S. Provisional Application No. 61/168,997 filed Apr. 14, 2009, U.S. Provisional Application No. 61/183,151 filed Jun. 2, 2009, U.S. Provisional Application No. 61/185,410 filed Jun. 9, 2009, U.S. Provisional Application No. 61/220,899 filed Jun. 26, 2009, U.S. Provisional Application No. 61/236,776 filed Aug. 25, 2009, U.S. Provisional Application No. 61/259,058 filed Nov. 6, 2009, and U.S. Provisional Application No. 61/260,721 filed Nov. 12, 2009, which are incorporated by reference as if fully set forth herein.

### FIELD OF INVENTION

This application is related to wireless communications.

### BACKGROUND

During the initial phase of the long term evolution (LTE)/service architecture evolution (SAE) standardization, universal integrated circuit card (UICC)-less emergency calls are not supported. Thus, wireless transmit/receive units (WTRUs) that do not provide valid credentials are barred from accessing the evolved universal mobile telecommunications system (UMTS) terrestrial radio access network (E-UTRAN) and evolved packet system (EPS) domains even when these accesses are intended for emergency purposes. An emergency call may be placed using a voice application that may be transported over the packet network for WTRUs with a valid UICC. However, this may be transparent to the E-UTRAN and EPS domains.

Possible area emergency call establishment alternatives include a redirection mechanism and circuit switched fallback (CSFB). However, in both these cases, the actual voice call may be established in the circuit switched (CS) domain by, e.g., falling back to legacy radio access technology (RAT) networks, such as a global system for mobile communications (GSM)/edge radio access network (GERAN) or UTRAN.

The requirements for the support of Internet protocol (IP) multimedia subsystem (IMS) emergency calls over EPS may include, in at least most cases, (e.g., home, roaming, normal mode, limited service mode), emergency connectivity to an emergency access point name (APN). The WTRU initiates the emergency connectivity upon recognition of a dialed emergency number. This connectivity is limited to using emergency services available at the packet data network (PDN) served by the emergency APN, via static rules, (thus there is no impact on policy control and charging (PCC)).

The requirements for the support of IMS emergency calls over EPS may further include the mobility management entity (MME) always including the “emergency support indication” in the response to the WTRU on attach and tracking area update (TAU), (attach accept, TAU accept, routing area update (RAU) accept), in order to inform the WTRU whether or not the network supports the emergency APN.

There are certain scenarios in which the initial/normal attach procedure fails in E-UTRAN. When this happens, the WTRU receives an attach reject message with a cause that indicates the reason of failure. Some reasons are purely related to mobility management, e.g., public land mobile network (PLMN) not allowed, tracking area not allowed, etc. However, another reason for possible rejection of an attach procedure is a failure in the related evolved packet system (EPS) session management (ESM) procedure, i.e., the activation of a default EPS bearer context which occurs as part of the attach procedure. Thus, failure of the ESM procedure implicitly leads to failure of the attach procedure.

Depending on the operator policy and/or local regulation, the MME may allow or reject requests for emergency service based on the emergency bearer service support type. There are four options for emergency bearer service.

The first option provides emergency bearer service to valid WTRUs only. No limited service state WTRUs are supported in the network. Only normal WTRUs that have a valid subscription are authenticated and authorized for packet switched (PS) service in the attached location are allowed. It is not expected that a normal WTRU would perform an emergency attach. Normal WTRUs may be attached to the network and then perform a PDN connection request when an IMS emergency session is detected by the WTRU.

The second option provides emergency bearer service only to WTRUs that are authenticated. These WTRUs must have a valid international mobile subscribed entity (IMSI). These WTRUs are authenticated and may be in limited service state due to being in a location that they are restricted from service. A WTRU that may not be authenticated will be rejected.

The third option provides emergency bearer service only to WTRUs that have an IMSI and, optionally, WTRUs that are authenticated. If authentication fails, the WTRU is granted access and the unauthenticated IMSI retained in the network for recording purposes. The international mobile equipment identity (IMEI) is used in the network as the WTRU identifier. IMEI-only WTRUs will be rejected (e.g., UICC-less WTRUs).

The fourth option provides emergency bearer service to all WTRUs. Along with authenticated WTRUs, the fourth option includes WTRUs with an IMSI that may not be authenticated, and WTRUs with only an IMEI. If an unauthenticated IMSI is provided by the WTRU, the unauthenticated IMSI is retained in the network for recording purposes. The IMEI is used in the network to identify the WTRU.

Since emergency calls are time sensitive, it is crucial to avoid unnecessary delays (e.g., due to determining the type of WTRU, determining whether or not a WTRU is registered in a core network, or determining whether or not a WTRU is in a connected mode). Therefore, it is highly desirable to find solutions that simplify emergency call setup procedures while minimizing emergency call setup delays.

### SUMMARY

A method and apparatus are described for processing emergency calls by simplifying call setup procedures and minimizing call setup delay. In one scenario, a system information (SI) broadcast may include emergency services support information that conveys various emergency call network support levels and setup procedures. The SI broadcast is decoded to retrieve system parameters used to process an emergency call. The SI broadcast may include a bitmap or at least one information element (IE), that indicates the various emergency call network support levels. In another scenario, an extended service request message indicating CSFB for an emergency call is transmitted to a PS RAT network during a PS session. An inter-system change is performed from the PS RAT network to a CS RAT without a PS handover, and a CS emergency call is initiated via the CS RAT network.

### BRIEF DESCRIPTION OF THE DRAWINGS

A more detailed understanding may be had from the following description, given by way of example in conjunction with the accompanying drawings wherein:

FIG. 1 shows an example of a wireless communication system including a plurality of wireless transmit/receive units (WTRUs) and an eNB;

FIG. 2 show an example of a functional block diagram of the WTRUs and eNBs of FIG. 1;

FIG. 3 shows an example embodiment of when a WTRU is registered or unregistered;

FIG. 4 shows an example of a block diagram of a WTRU communicating with a network;

FIG. 5 is a representation of how a CS emergency call may be processed; and

FIG. 6 is a flow diagram of a procedure for processing a CS emergency call.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of device capable of operating in a wireless environment.

When referred to hereafter, the terminology “base station” includes but is not limited to a Node-B, evolved Node-B (eNB), a site controller, an access point (AP), or any other type of interfacing device capable of operating in a wireless environment.

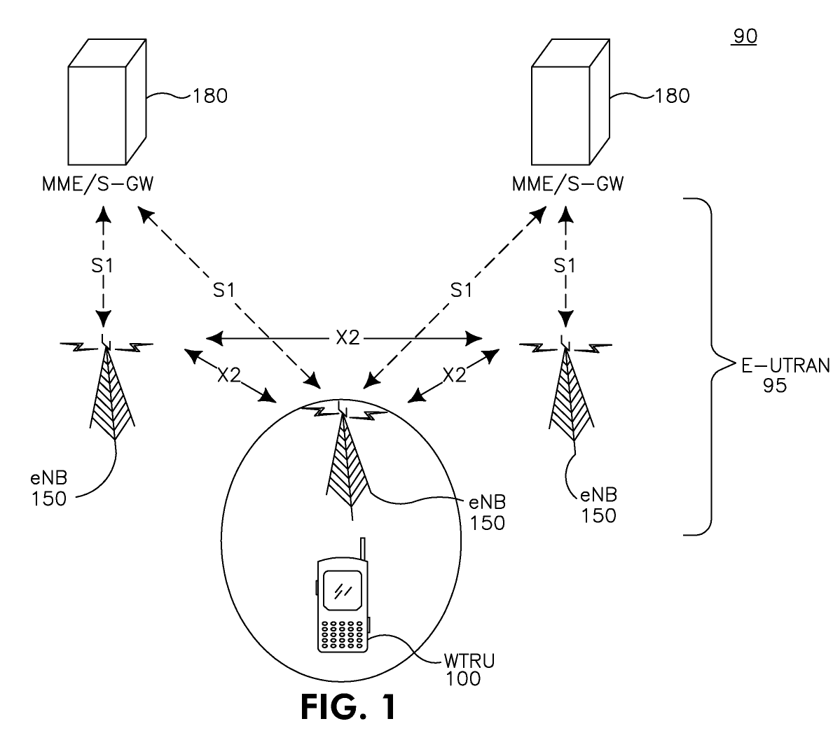

FIG. 1 shows an LTE wireless communication system/access network 90 that includes an E-UTRAN 95. The E-UTRAN 95 includes several eNBs 150. A WTRU 100 is in communication with an eNB 150. The eNBs 150 interface with each other using an X2 interface. Each of the eNBs 150 interface with an MME/serving gateway (S-GW) 180 through an S1 interface. Although a single WTRU 100 and three eNBs 150 are shown in FIG. 1, it should be apparent that any combination of wireless and wired devices may be included in the LTE wireless communication system/access network 90.

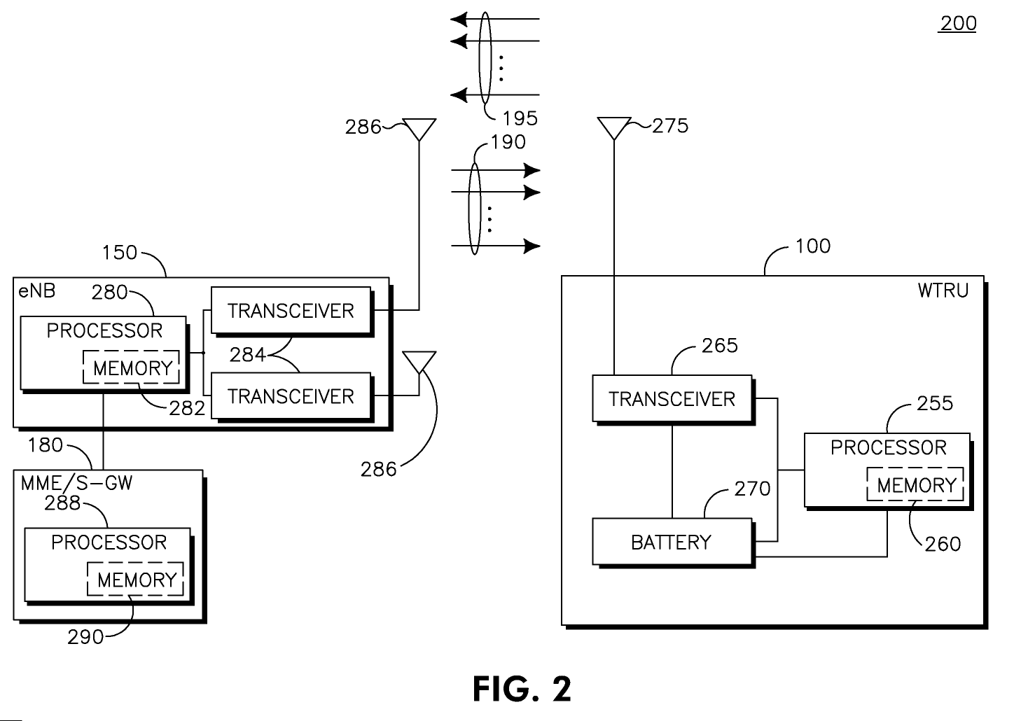

FIG. 2 is an example of a block diagram of an LTE wireless communication system 200 including the WTRU 100, the eNB 150, and the MME/S-GW 180. As shown in FIG. 2, the WTRU 100, the eNB 150 and the MME/S-GW 180 are configured to process emergency calls.

In addition to the components that may be found in a typical WTRU, the WTRU 100 includes a processor 255 with an optional linked memory 260, at least one transceiver 265, an optional battery 270, and an antenna 275. The processor 255 is configured to process emergency calls. The transceiver 265 is in communication with the processor 255 and the antenna 275 to facilitate the transmission and reception of wireless communications. In case a battery 270 is used in the WTRU 100, it powers the transceiver 265 and the processor 255.

In addition to the components that may be found in a typical eNB, the eNB 150 includes a processor 280 with an optional linked memory 282, transceivers 284, and antennas 286. The processor 280 is configured to process emergency calls. The transceivers 284 are in communication with the processor 280 and antennas 286 to facilitate the transmission and reception of wireless communications. The eNB 150 is connected to the MME/S-GW 180, which includes a processor 288 with an optional linked memory 290.

As shown in FIG. 2, the WTRU 100 is in communication with the eNB 150, and both are configured to perform a method wherein UL transmissions from the WTRU 100 are transmitted to the eNB 150 using multiple UL carriers 190, and DL transmissions are handled using multiple DL carriers 195.

### WTRUs Not Registered In Network

When a user powers up a WTRU in order to make an emergency call, the user may or may not be allowed to obtain normal services. The user may not even have a valid subscriber identity module (SIM) or universal SIM (USIM), or the WTRU may have attempted registration with the network but the registration failed due to network rejection, (e.g., PLMN not allowed, tracking area not allowed).

The network may broadcast what types of procedures are supported to provide emergency calls in the current PLMN or RAT network (E-UTRAN/UTRAN) via the current cell for access. This may be performed by inserting a bitmap in one or more system information blocks (SIBs), where the value of each bit, in the bitmap, represents whether or not the network supports certain types of emergency call setup procedures. The supported types may, for example (but not limited to these cases), be emergency calls in IMS, voice over IP (VoIP) calls, or establishment of data connections for emergency purposes, CSFB, or CS over EPS (CSoPS).

After being powered on in an E-UTRAN RAT, the WTRU will, after finding and synchronizing with a cell, start decoding SIBs in order to retrieve vital system parameters. At this point, the WTRU may find out what types of support exist for the emergency calls in the E-UTRAN.

In addition to inserting a bitmap in the system information (SI) broadcast, the network may provide emergency services support information to WTRUs using a new IE which may be utilized to convey the various emergency call support levels. However, since this information is crucial, it is highly recommended that the network support level, regardless of the chosen method, (bitmap or IE), should exist in all or at least the most important SIBs.

In order to provide emergency services support information to a WTRU, the bitmap, (which includes details of network supported procedures), may be transmitted in a special fast-changing SIB which is transmitted periodically to the WTRU at a higher periodicity than other SIBs. This may assist the WTRU in acquiring the information more reliably and, if required, start the call after acquiring this SIB and other critical SIBs (e.g., master information block (MIB), SIB1 and SIB2) without waiting to acquire all of the other SIBs (e.g., SIB3 to SIB11, and possibly beyond). Alternatively, the bitmap or another other method used to convey the information may also be transmitted in one of the critical MIB/SIBs, i.e., MIB, SIB1 or SIB2, so that the WTRU may acquire this information and start the call procedure without waiting to acquire all of the other SIBs (SIB3 to SIB11, and possibly beyond).

As an alternative to relying on network support, the WTRU may immediately notify the network of its own various capabilities for supporting emergency calls. The WTRU may start the communication with the E-UTRAN by sending a radio resource control (RRC) connection request message. Therefore, a new bitmap may be specified where the WTRU may notify the E-UTRAN what versions of emergency calls it supports. When the WTRU sends this message, it is mandatory to indicate that the “establishment cause”, for the connection request, is an “emergency call”. The combination of the “establishment cause =emergency call” and the WTRU capability bitmap may assist the E-UTRAN in taking proper actions for the most conceivable call setup.

The WTRU may indicate its emergency call capabilities by transmitting a random access preamble to the E-UTRAN prior to sending an actual RRC connection request message. On this preamble, the WTRU may send a sequence of bits with limited length. A set of defined preambles may be used (during random access) for the purpose of establishing a radio connection to perform emergency calls. This minimizes collisions in random access due to the selection of the same preamble by at least two WTRUs. A particular WTRU may use a predefined sequence as an emergency call preamble. As an alternative, one or several bit positions, within the sequence, may be chosen to serve the same purpose. By doing this, the E-UTRAN may then give the highest priority, for access, to the particular WTRU in case several WTRUs have asked for resources.

Each cell may signal a set of preambles reserved for emergency access for that cell on the SI message, along with random access channel (RACH) parameters. The WTRU may use those preambles for starting an emergency call.

In addition to indicating the emergency in the RRC connection request, optimization may be performed at the random access procedure level to minimize RACH collision probability and to alert the eNB for winning the collision in case one or two signatures in the uplink RACH access may be reserved for emergency calls only, one or two fixed values are reserved in the preamble random-identity (ID) (5-bit) field for emergency calls only, or if augmentation of the preamble is possible, 1-bit is defined to indicate the emergency or special call request.

Another well-known function in conjunction with the random access procedure is the initial power calculation for the preamble followed up by the power ramping steps. In order to optimize this procedure, so that the WTRU may reach the desired power level factor, the WTRU may start with a higher initial transmit power when the preamble is sent due to the emergency call request. This may be performed by applying an offset, (e.g., N dB, where N is a positive integer), to the initial target power. As a first solution, the offset value is signaled to the WTRU through an indication in one or more SIBs. Alternatively, a default offset value may be specified which may always be applied for the emergency calls.

Also to speed up the procedure, if the RACH procedure is for an emergency call, the processing delay requirements may possibly be relaxed, (e.g., if the user starts up the WTRU to make an emergency call, then the RACH procedure may be an initial RACH procedure). In this case, the WTRU may not apply the timing advance (TA) in the RACH response message until n+6 sub-frames after the RACH response is received. Subsequently, the WTRU may not send the RRC connection request at least until at least n+6 sub-frames after receiving the RACH response. In case of emergency calls, this restriction may be removed allowing the WTRU to work on the grant and send the RRC connection request message much faster, (e.g., the WTRU may use a normal grant processing delay for emergency calls, apply the TA and send the RRC connection request n+4 sub-frames after receiving the RACH response).

The WTRU may attempt to initiate an emergency call in EPS after a normal registration, (e.g., attach), which is also referred to as being in a “normal state”. Thus, the WTRU may have to initiate a PDN connectivity procedure using a special emergency APN, as well as a quality of service negotiation that supports the IMS emergency call. This will create some level of delay in the bearer setup (or call setup) procedure. One possible way to speed up the call setup would be that the WTRU is allocated a specific bearer (i.e., an “emergency bearer”) prior to requesting the call setup. Note that EPS R8 does not provide any mechanism to do this during the attach procedure. Therefore, a method to combat this associated delay is described below.

During the “normal” attach, the WTRU may indicate to the MME, in an attach request message, that it is capable of receiving information about and creating the emergency bearer already in the attach accept message. This may be performed by the WTRU sending a release indicator (e.g., release 9 (R9) or later). This release indicator may be sent as part of the WTRU capabilities, or as a new IE in the attach request message. Upon receiving this indication from the WTRU, an R9 compatible MME may then allocate an “emergency bearer”, in addition to the “default bearer”, and send it to the WTRU in the attach accept message. The WTRU may maintain the emergency bearer until a detach procedure is performed, or a new indication from the network about possible changes of the bearer is received. The network may always modify/change the emergency bearer by using already specified ESM messages, or by including the ESM message container in other EPS mobility management (EMM) or EPS connection management (ECM) messages.

As an alternative, or in addition, the network may allocate an emergency bearer at inter-MME handover or inter-system handover. This may be performed through a TAU or a handover message.

Moreover, the network may inform the WTRU about support of emergency APN in messages such as attach accept, TAU accept, attach reject, or TAU reject. However, since R8 WTRUs are not equipped with such support, adding this indication in such messages may lead to an erroneous interpretation by the WTRU. Thus, the MME may include or exclude this indication, depending on the WTRU release. For example, if the MME knows that a particular WTRU (that is attempting to register) is an R9 WTRU or later WTRU (e.g., with the use of the release indicator described above), the MME will include the necessary emergency support indications. However, if the MME knows that a WTRU is an R8 WTRU (e.g., due to missing release indication from the WTRU), the MME will not include this information.

However, if an R8 receives such indication, e.g., due to errors in the MME, the WTRU may ignore the indication and carry on with the registration. Another option is that the WTRU rejects the registration with the necessary reject cause.

In addition, an R9 or later release WTRU may include its release indicator when it is aware that the MME (or network nodes) is also R9 or later. This may be known from the SI messages or via dedicated messaging, (e.g., with RRC messages during inter-system change (i.e., handover, cell change order, or RRC connection release with redirection information)). Thus, an R9 WTRU or later WTRU will not include its release indicator when registering to an R8 network/MME unless there are mechanisms to correctly interpret this at the network/MME.

### Requesting Emergency State/Obtaining an IP Address

When registering to the network, the WTRU normally sends an attach request message which also includes a PDN connectivity request message. The latter serves the purpose of obtaining a connection to a PDN gateway (PDNG), which is responsible for providing an IP address to the WTRU. If the network accepts the registration, it replies with an attach accept message, which also includes a response to the request for PDNG connection. After a message exchange between the WTRU and the network (handshake), the WTRU finally gets a default bearer context activated and obtains an IP address.

If the WTRU is not registered to the network and attempts to place an emergency call, the WTRU may send a new registration message, e.g., “emergency attach”) that may be piggybacked with any of the RRC messages, (e.g., RRC connection complete, or as a standalone non-access stratum (NAS) message after RRC connection establishment). This new message may be used as an indication to speed up the registration procedure.

One possible way to speed up the registration procedure is to minimize the number of messages (handshake) sent back and forth between the WTRU and the network, that finally results in assigning an IP address to the WTRU. The registration message may be sent with or without a PDN connectivity request in order to speed up the processing at both the WTRU and the network sides. However, the network will still do the necessary steps required to assign an IP address to the WTRU.

Moreover, when the network sends a response to the “emergency attach,” the handshake may be considered complete at this point (as compared to the normal case where the WTRU still sends a third message to complete the procedure). Moreover, the WTRU may be assigned an IP address that may be used to for the emergency call.

The network may activate a new EPS bearer context (i.e., “emergency bearer context”) for the WTRU. Moreover, the network (optionally) may use a specific PDNG for obtaining emergency services. The WTRU may indicate the APN corresponding to this PDNG in the registration message. This APN may be pre-configured in the WTRU, obtained during a previous access to the network, or may be broadcasted.

Also, this context may never be deactivated as long as the WTRU is registered to the network. Thus, the WTRU will always have a context setup for emergency calls, and thus a PDN connection for this purpose. Thus, a deactivated EPS bearer context for emergency calls indicates that the WTRU is either detached or in limited service mode.

The EPS bearer context for emergency calls may be modified. However, it is desirable not to modify this context after it has been activated according to the required/necessary parameters for emergency calls. This avoids downgrading the service if somehow the context is modified to provide a lower quality of service.

In addition, a PDNG may select a set of IP addresses that may be quickly assigned to WTRUs that request connection for emergency service. This may minimize delays that otherwise will exist if a dynamic host configuration protocol (DHCP) is used to obtain a new IP address.

To enable the emergency call from WTRUs without a SIM or USIM, an additional request cause type “originating emergency without SIM” in an RRC connection request may be used when the WTRU is in a limited service state. The purpose of this indication is to indicate to the network for skipping some of the WTRU registration procedures, such as the authentication procedures, since the WTRU does not have a SIM/USIM to perform the authentication and, optionally, for skipping the attach procedure.

For the purpose of emergency calls, the network may provide an IP address to the WTRU, even if the WTRU is not subscribed for this type of IP address. For example, the WTRU may request an IPv6 address, but the subscription profile for this user only allows an IPv4 address allocation. Thus, it is desirable to remove or relax as many restrictions as possible in order to grant an emergency service to a WTRU with minimal delay.

In a conventional third generation partnership project (3GPP) system, the WTRU may set the PDN type IE in the PDN connectivity request message, based on its IP stack configuration as shown by the following examples:
1) A WTRU which is IPv6 and IPv4 capable and has not been allocated an IP address for this APN may set the PDN type IE to IPv4v6, has been allocated an IPv4 address for this APN and received the ESM cause #52, “single address bearers only allowed,” and is requesting an IPv6 address, may set the PDN type IE to IPv6, and has been allocated an IPv6 address for this APN and received the ESM cause #52, “single address bearers only allowed,” and is requesting an IPv4 address, may set the PDN type IE to IPv4.
2) A WTRU which is only IPv4 capable may set the PDN type IE to IPv4.
3) A WTRU which is only IPv6 capable may set the PDN type IE to IPv6.
4) When the IP version capability of the WTRU is unknown in the WTRU (as in the case when the mobile terminal (MT) and terminal equipment (TE) are separated and the capability of the TE is not known in the MT), the WTRU may set the PDN type IE to IPv4v6.

The WTRU may set the PDN connectivity type according to the emergency service needs instead of setting the PDN connectivity type based on what the WTRU supports. For example, the WTRU may support both IPv4 and IPv6, and the WTRU in this case may set the request type to IPv4v6. However, if the PDN request type is set to IPv4v6, the network may provide either IPv4 or IPv6 based on the user subscription and/or network policies.

Thus, in order to avoid delays and allocation of an unwanted IP address type, the WTRU may set the PDN request type based on what is needed to support the emergency call. For example, the WTRU may set the PDN request type to IPv6 if the WTRU knows that its emergency service needs IPv6, (due to its IMS capability that needs IPv6 addressing), even if IPv4 is also supported by the WTRU.

In LTE, the IP address is provided upon attachment to the network. Upon attachment, the WTRU gets allocated an IP address based on what its emergency service would need (as explained above). For example, if the WTRU is IMS capable and IMS emergency calls are supported with IPv6 addressing, the WTRU gets allocated an IPv6 address upon attachment. The WTRU may then request another PDN connection to receive an IPv4 address for other needs.

Alternatively, the WTRU may first attach and receive any IP address based on normal procedures. The WTRU may then request another PDN connection to get an IP address for its emergency needs. In this case, the second PDN connectivity request may be initiated before the WTRU completes its attach procedure (i.e., after sending the attach message but before completion of the procedure).

### The WTRU is Registered in the Network

The WTRU normally starts the registration phase with an “attach” procedure. After the attach procedure, subsequent registrations may be performed by using a TAU. The WTRU capabilities are conveyed to the network in the initial phase of both procedures. The WTRU may send its “preferences” for the emergency call establishment either along with its capabilities or as a new IE in the attach/TAU request.

In both cases, the procedures are finalized by an “accept” message (attach/TAU accept) sent from the network to the WTRU. The network may include a list of “preferred” emergency call solutions to be used by both the WTRU and the network. As an alternative solution, the list may also be communicated to the WTRU during the release of the signaling connection, (i.e., in the RRC connection release message).

The network (and the WTRU) may optionally activate an EPS bearer context for emergency calls, e.g., an EPS emergency bearer context, upon registration (similar to the default EPS bearer context). In this case, the WTRU may use the activated bearer context when performing emergency calls, and the network will setup the radio bearers associated with this context when the WTRU requests an emergency call. Moreover, the network will only setup radio bearers for the associated bearer context, (or any other bearer context that will be used for emergency call, e.g., the default context), when the WTRU requests emergency service. This ensures minimal processing in order to place the emergency service.

Alternatively, the network may send such information in other NAS messages, e.g., EMM information. This may be used to convey the information when the WTRU is in connected mode and hence no TAU will be initiated.

The WTRU may send “assisted positioning data” to the network during the registration procedure. These assisted positioning data may be sent periodically where the period may be specified in conjunction to the emergency calls.

In the case that the WTRU capability sent to the network does not include the emergency call support types, the PLMN and access network may send its supported emergency call support types, (the bitmap or the IE mentioned before), to the WTRU via messages such as the attach accept or TAU accept.

The WTRU may request emergency call establishment by sending the “service request” message where a new code-point in the “security header type” may be assigned to indicate a “request for the emergency call establishment.”

The WTRU may also request emergency call establishment by sending the “extended service request” message where a new code-point in the “service type IE” may be assigned for the “emergency call establishment”. Note that this differs from the current structure of the service type IE where there already exists a code-point to indicate a “mobile originating CSFB emergency call”. The existing code-point only relates to the CSFB, whereas this solution may be applied to any chosen method so long that both the WTRU and the network support it.

If neither service request nor extended service request may be deemed as an acceptable solution, a new NAS message may be defined in order to convey the emergency call request by the WTRU. This new NAS message may be structured to have a rather short length in order to allow the piggy-backing over the radio interface (RRC) messages.

Given that the WTRU has powered up already and if the WTRU is equipped with a positioning device, (e.g., global positioning system (GPS)), the coordinates of the WTRU may be conveyed at the RRC connection request so that the location of the emergency is made known, regardless of whether the emergency call is successful or not.

In the event that a WTRU establishes an emergency in a legacy network, it may be possible that immediately after the call is established, the radio conditions are such that a handover towards a prospective E-UTRAN network is warranted. In a legacy system, it is possible for a UICC-less WTRU to place an emergency call. Therefore, it is necessary to modify RRC connection procedures and NAS procedures to allow establishment of signaling radio bearers (SRBs) and data radio bearers (DRBs).

In one example, the reception of a handover message may be allowed for special cases, such as emergency calls, even when security has not been activated.

In another example, the context received from the EPS may indicate to the E-UTRAN that the handover is that of an emergency call or any other similar special service. This may trigger the E-UTRAN to execute a “modify security procedure” or skip this procedure altogether. As an example, the SRB2 and DRBs may still be established even if security procedures are not executed for these types of calls/services.

As an alternative or in addition, the WTRU or the network may use special dummy security keys or special security configurations only for handover and connection re-establishment for emergency call cases.

As an alternative in the case of emergency calls, the network may signal a bit or an IE in the initial messages informing the WTRU that a security procedure may not be performed in the call before handover to ensure that the WTRU realizes this and does not reject the procedure as erroneous.

If the emergency call continues in the E-UTRAN in the PS domain, the network needs to ensure that sufficient resources are consistently allocated to the WTRU. The network, using the examples mentioned above, may understand that the PS call may actually be used for emergency purposes. Thus, the network may ensure that a semi-persistent grant is always allocated to the WTRU.

Alternatively, or in addition, the WTRU in the initial call establishment messages or any other RRC messages may request for a grant to be consistently allocated, and thus the network may rely on the WTRU performing such a request.

Additionally, for emergency calls, the WTRU may prioritize the semi-persistent grant or the semi-persistent radio network temporary identifier (RNTI) over all other grants or (RNTIs) to ensure that the emergency call is not interrupted.

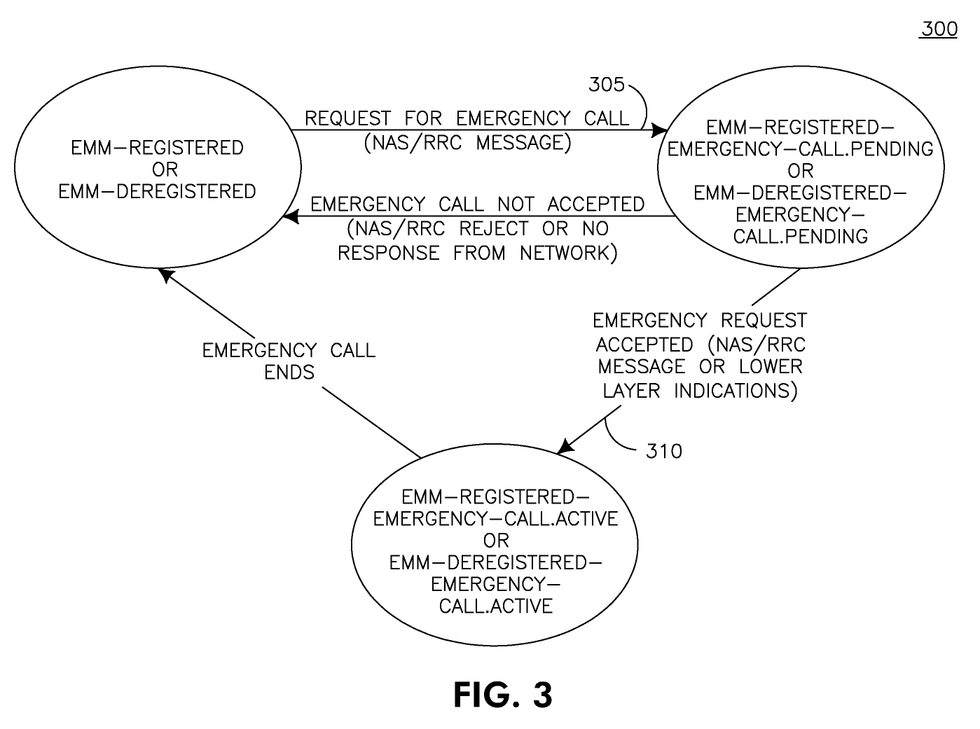

FIG. 3 shows an example of a procedure 300 used when a WTRU is registered or deregistered. The WTRU may enter a new state (or substate) when a request for an emergency call is placed. For example, as shown in FIG. 3, “emergency-call.pending” may be entered when the WTRU sends a NAS or RRC message 305 requesting an emergency call. The state may change to “emergency call active” when a response 310 is received from the network indicating that the request was accepted. The response 310 may either be another NAS/RRC message or indications from lower layers that the radio bearers have been setup for the emergency call. This new state and/or events for state transition may also exist on the network side.

When in this state, (or when placing an emergency call even if no new state is used), no other EMM (or ESM) procedure will be started as long as it is not related to the emergency call. Moreover, the emergency call will have priority over all other ongoing procedures, e.g., TAU. Thus, the network and the WTRU will process this procedure and ignore any ongoing procedures.

Alternatively, if an emergency call is dialed when a TAU is about to be performed, the WTRU may set the active bit flag in the TAU request. The network, in addition to setting up the radio and S1 bearers for all active EPS bearer context, may take the necessary actions to support emergency calls. For example, this may be setting up radio and S1 bearers for the emergency EPS bearer context or activating a PDN connection for an emergency call, or allocating an IP address for an emergency call. Thus, the network will complete whatever is needed assuming an emergency call request has been made.

All of the examples described above may apply to the cases when the WTRU is registered or not registered with the network.

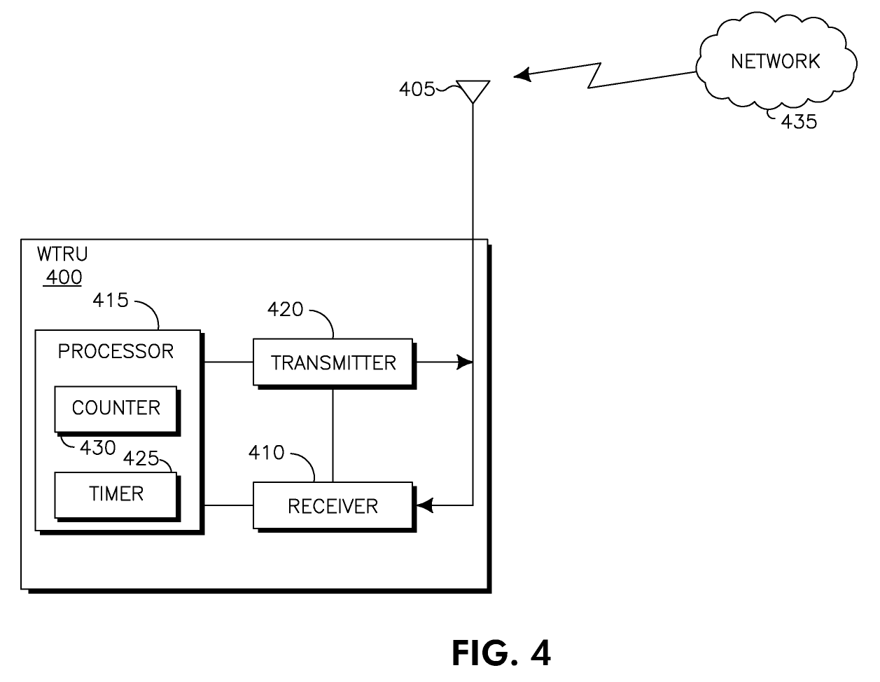

FIG. 4 is an example of a block diagram of a WTRU 400. The WTRU 400 may include an antenna 405, a receiver 410, a processor 415 and a transmitter 420. The processor 415 may include at least one timer 425 and at least one counter 430. The WTRU 400 communicates with a network 435.

The timer 425 in the WTRU 400 may be started when an emergency call is requested. For example, the timer 425 may be set to a duration of two seconds. The timer 425 is stopped normally if the WTRU 400 receives a response from the network 435, (e.g., an accept response or a reject response). If the timer 425 expires without a response, the WTRU 400 may take other actions (e.g., change RATs).

A new release cause may be indicated when a connection related to an emergency service is released. This new release cause may be used to change states or to take any other necessary action.

The techniques described above may also be implemented in the network 435. For example, a timer may be started when the network 435 sends a response to the WTRU 400.

Alternatively, the counter 430 in the WTRU 400 may be used to monitor the number of attempts to make an emergency call request, (such as emergency attach or other NAS messages needed for this purpose). A failure of the procedure increments the counter 430. The WTRU 400 may take necessary actions after the counter 430 reaches a predefined value (e.g., two attempts), after which the WTRU 400 reselects to a RAT network that, unlike E-UTRAN, provides CS services as well.

In addition, the counter 430 may be used with the timer 425. Thus, the WTRU 400 may take necessary actions when one event occurs before the other, (i.e., the counter 430 reaches its maximum value before the timer 425 expires, or the timer 425 expires before the counter 430 reaches its maximum value).

### The WTRU is in Connected Mode

It is possible that the WTRU is in connected mode, with at least one ongoing PS session, when a request for emergency service occurs. It is assumed that the WTRU has already activated an EPS bearer context for the purpose of en emergency service (referred to as emergency bearer context). This means that the configurations/parameters for emergency calls are already known to the WTRU but no bearers are necessarily setup for the purpose of emergency call.

All the necessary bearers (radio, S1, S5, S8) may be setup when the WTRU goes from idle mode to connected mode even if the reason is not for emergency (e.g., due to pending user data).

Another option is to partially setup the necessary bearers. For example, the network may call setup the radio and S1 bearers, (between the WTRU and the serving gateway), but the bearer between the serving gateway and the PDN gateway, (via which emergency services are provided), may be established later when an emergency data transfer starts.

Alternatively, when transitioning from idle to connected mode for the purpose of signaling or user data, (or anything except for emergency reason), the necessary radio (and S1 and S5) bearers for emergency calls (corresponding to the emergency bearer context) need not be setup. Thus, when the WTRU is in connected mode, (e.g., due to user data), a new indication is required to inform the network about a request for an emergency call if one is needed. Therefore, a NAS message for this reason may be sent.

One way of achieving this functionality is to re-use the extended service request with a different code point, (since currently this message is solely used for the purpose of circuit switched fallback), as this message may be sent in connected mode. Alternatively, a new NAS message may be defined for this purpose, (e.g., an emergency service request).

The WTRU may be assigned an IP address, which may be used for emergency services, during the attach procedure or at the time of requesting emergency services. If an IP address is not allocated previously, the network may do so when it receives a NAS message indicating the user's request for emergency service.

The WTRU may indicate the type of IP address it requires for emergency services in the NAS message described above. In response, the network sends a response message in which an IP address is included for emergency services. Other necessary parameters may also be included in the response message.

Furthermore, the network may suspend the WTRU's contexts, except that of the emergency, until the emergency call is ended. For example, the network may not locally deactivate a non-emergency EPS bearer context, since it is not expected that such context, (e.g., for web browsing or gaming), will be used during the emergency call.

In addition, any time-based service subscription may be suspended until the emergency call has ended. For example, if a WTRU is on a closed subscriber group (CSG) cell for a specified time as indicated by the subscription, the network may suspend the subscription timer until the emergency call is finished. The WTRU may resume its regular services again after the emergency call.

The network may indicate the suspension of the WTRU's context and its subsequent resumption via signaling messages including NAS, RRC, open mobile alliance (OMA), or any other messages.

For the purpose of emergency calls, the network and/or the WTRU accept the necessary messages even if some errors exist in the values of the included IEs. For example, if the WTRU or the network uses a bearer identity that is reserved, the recipient of the message may not send a reject response (which is normally the case for non-emergency bearers). The response may include a new correct value or may include the same erroneous value.

A predefined bearer identity may be used for the purpose of emergency calls. This may be a value from the non-reserved bearers or from the bearers which are considered reserved.

### WTRU Mode of Operation and IMS Emergency Support

Another aspect to consider is the WTRU's mode of operation and the impact on emergency calls. In a PS mode of operation, the WTRU registers only to EPS services. In a CS/PS mode 1 of operation, the WTRU is CSFB capable and configured to use CSFB, and non-EPS services are preferred. The WTRU registers to both EPS and non-EPS services. In a CS/PS mode 2 of operation, the WTRU is CSFB capable and configured to use CSFB, and EPS services are preferred. The WTRU registers to both EPS and non-EPS services.

It is expected that the user will modify the mode of operation that will have impact on the selection of RATs. For example, if the WTRU is in CS/PS mode 1 and performs a combined registration which fails, the WTRU may deactivate E-UTRAN capabilities and select a CS RAT network since emergency calls would not have been possible in E-UTRAN, (due to combined registration failure no CSFB may be performed).

Assuming CSFB is not supported in the network (or combined registration fails) and the WTRU is in CS/PS mode 1 and IMS emergency service is supported, although the CS is preferred, the WTRU does not deactivate the E-UTRAN capabilities.

### Other States in the WTRU

Referring again to FIG. 4, if the WTRU 400 enters an EMM-deregistered attempting-to-attach state or an EMM-registered. attempting-to-update state, then the timer 425 (e.g., T3411), (which runs for 10 seconds), is started. In the event that the timer 425 expires, the WTRU 400 may send another attach request or TAU request for the respective states above. If a request for an emergency call arrives, the WTRU 400 may not wait for the timer 425 to expire before resending the necessary message.

Alternatively, the WTRU 400 enters a limited service mode, (if emergency services are supported in this state), and attempts an emergency attach or emergency TAU. Thus, the WTRU 400 may not have to wait for the timer 425 to expire before an emergency call may be placed. However, if emergency services are not supported in a limited service mode, the WTRU 400 may reselect to a CS RAT network in order to request the emergency call that is dialed by the user. The same solution may apply to any other state in the WTRU 400 for which the timer 425 governs the resending of the necessary message, e.g., other substates of the EMM-deregistered and EMM-registered main states and timers 425 (e.g., such as T3402 whose length is twelve minutes).

### CSFB and Emergency Service

CSFB may be used for emergency calls when the WTRU is both EPS/IMSI registered or attached. For emergency calls with CSFB, the WTRU may send an extended service request message and sets the service type to “mobile originating CSFB emergency call” or “1×CSFB emergency call.” According to the CSFB procedure, the WTRU's PS session may be handed over to the target RAT network, (if the WTRU had an ongoing PS session in LTE), and then the WTRU may initiate the CS call.

In the case of emergency calls, the CS call may be initiated first in the target RAT. One way of achieving this functionality is by suspending a WTRU's PS session in LTE and performing an inter-system change to a CS RAT network without a PS handover. This will reduce the delays that would otherwise be incurred for CSFB. Another option is not to suspend the PS session and start the CS call first in the target RAT. The PS session may be terminated and not handed over when the reason for CSFB is emergency service.

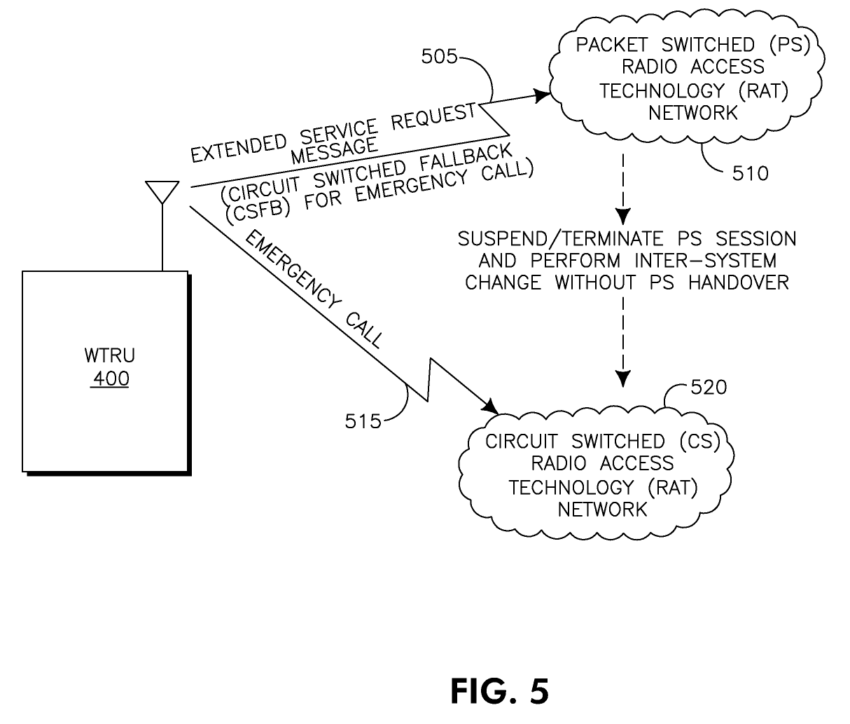

FIG. 5 is a representation of how a CS emergency call may be processed. A WTRU 400 transmits an extended service request message 505 to a PS RAT network 510 during a PS session. The extended service request message 505 indicates CSFB for an emergency call. An inter-system change is performed from the PS RAT network 510 to a CS RAT network 520 without PS handover, whereby the PS session of the WTRU 400 is either suspended or terminated. The WTRU 400 may then initiate a CS emergency call 515 via the CS RAT network 520.

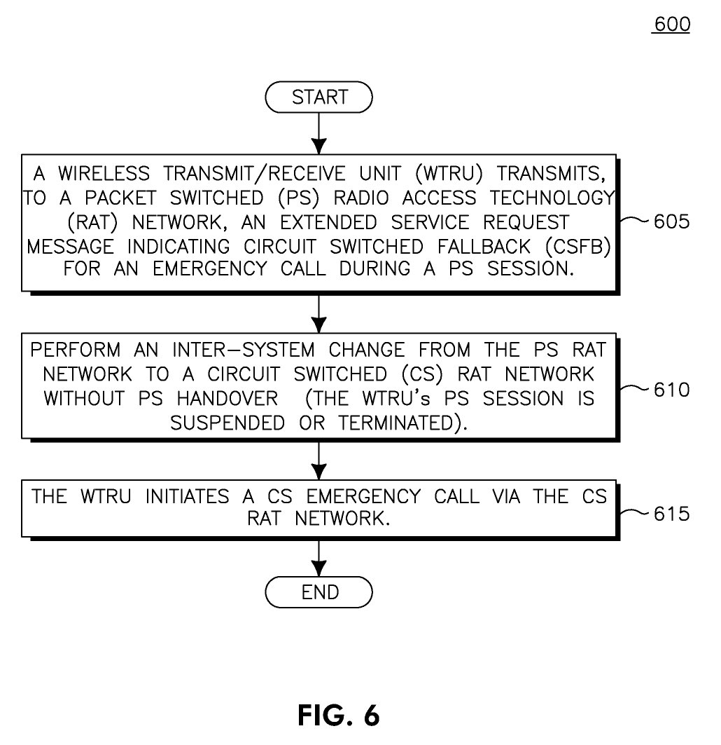

FIG. 6 is a flow diagram of a procedure 600 for processing a CS emergency call. A WTRU transmits an extended service request message to a PS RAT network during a PS session (605). The extended service request message indicates CSFB for an emergency call. An inter-system change is performed from the PS RAT network to a CS RAT network without PS handover (610), whereby the PS session of the WTRU is either suspended or terminated. The WTRU then initiates a CS emergency call via the CS RAT network (615).

Attach Reject because of Failure in ESM Procedure

Referring to FIG. 4, a counter 430 in the processor 415 of a WTRU 400 may be used to limit the number of subsequently rejected attach attempts. The maximum number of attach attempts that may be made is five. If the registration fails and the counter 430 counts less than five attach attempts, then a timer 425 (e.g., T3411, ten seconds) in the processor 415 is started and the state is changed to an EMM-deregistered.attempting-to-attach state. In the event that the timer 425 expires, the attach procedure may be restarted. If the counter 430 counts five attach attempts, the WTRU 400 may delete any globally unique temporary identity (GUTI), tracking area identity (TAI) list, last visited registered TAI, list of equivalent PLMNs and key set identifier (KSI), may set the update status to EU2 not updated, and may start another timer 425 (e.g., T3402). The state is changed to EMM-deregistered. attempting-to-attach or optionally to EMM-deregistered.PLMN-search in order to perform a PLMN selection.

If A/Gb mode or Iu mode is supported by the WTRU, the WTRU may in addition handle the global multimedia mobility (GMM) parameters, GMM state, general packet radio services (GPRS) update status, packet-temporary mobile subscriber identity (P-TMSI), P-TMSI signature, routing area identity (RAI) and GPRS ciphering key sequence number as conventionally specified for the abnormal case when a normal attach procedure fails and the attach attempt counter 430 in the WTRU 400 is equal to five.

However, if the attach procedure fails because of the failure of the simultaneous ESM procedure (i.e., default bearer activation and PDN connection), the WTRU may set the attempt counter to five, (even though its actual value is not five).

It is important to specify the WTRU behavior if the user has just powered up in order to place an emergency call, and the attach fails due to ESM. If the WTRU 400 does not set the attempt counter to five, then the timer 425 may be started and the re-attempt is made after 10 seconds. Thus, if an emergency call is pending, the WTRU 400 may set the attempt counter 430 to five and then directly initiate an emergency attach procedure.

Alternatively, if the attempt counter 430 is not set to five, the WTRU 400 may not wait for the expiry of the timer 425 before a new attach attempt is made. Moreover, the WTRU 400 may indicate that there is a pending emergency call, (e.g., by directly performing an emergency attach or including this indication in the regular attach procedure).

### NAS-Layer Indications for Type of Emergency Service

The specific/exact type of supported emergency services, (i.e., emergency for normal attached WTRUs, WTRUs with USIM that must be authenticated, WTRUs with USIM that may not be authenticated, or UICC-less WTRUs), be included by the network in the NAS messages including, but not limited to, attach accept, attach reject, TAU accept, TAU reject, service accept, or service reject. Similarly, for GERAN/UTRAN systems, the same indications may be included in the same messages where applicable (e.g., attach) and in location area update (LAU) or RAU.

Thus, if a WTRU receives indications of IMS emergency call support via the system information messages and this indication informs of an emergency service provision for WTRUs with UICC only, the information on the NAS may provide more details to the WTRU and hence be complementary (e.g., NAS layer indication specifies that emergency is provided for WTRUs that are normally attached or with UICC for which authentication may be performed successfully).

The WTRU uses these indications to take the necessary actions related to acquiring emergency services (or moving to another RAT) when certain events occur.

As an example, if the indications specify support for normally attached WTRUs only, then the WTRU may choose to directly camp on another RAT network as soon as the UICC is removed. Another option is that a WTRU without a USIM may remain on its current RAT network, as long as an emergency number is not dialed. The WTRU may attempt an emergency call request on another RAT network when an emergency number is dialed if it knows that it may not obtain such services on its current RAT network due to a previous indication it received at the NAS and/or access stratum (AS) layer. This indication may take any form, (e.g., bitmap or a new IE).

A WTRU may be able to request a release of its RRC connection (or request redirection to another RAT network) when emergency services may not be provided, and an inter-system change to another RAT network is needed for performing emergency calls. This may be useful, for example, when the MME, (or serving gateway or PDN gateway), rejects a request for emergency service and the reject message (usually a NAS message) is transparent to the RRC layer. As such, the eNB is not aware of the reason why the emergency call may not be placed, and thus may not know if the connection may be released or if the WTRU needs to be directed to another RAT network. Thus, the WTRU sends such a request to release the connection or to trigger an inter-system change when such a case arises and/or if the WTRU is not allowed to locally release its connection and change its RAT network.

Optionally, the MME may provide an indication to the eNB about the rejection and the eNB may then trigger inter-system change by sending inter-system change commands or by releasing the connection and providing redirection information to the WTRU. The procedures described herein apply to E-UTRAN, UTRAN, GERAN, and any other RAT network, e.g., code division multiple access 2000 (CDMA2000). Furthermore, the described alternatives are not limited to emergency call support with IMS only.

WTRU on a Cell/PLMN that does not Provide Emergency Calls

When in EMM connected mode with an ongoing PS session, the WTRU's EMM state is EMM-registered.normal-service. A WTRU may not perform an emergency attach procedure unless it is in a limited substate, i.e., either in EMM-registered.limited-service or EMM-deregistered.limited-service. There may be various reasons for entering these states in the WTRU, and these may be the result of registration attempts that may either succeed or fail. Thus, the WTRU is not allowed to autonomously change its EMM state. Instead, the WTRU has to follow the conventional behavior.

The WTRU's state (without any input from the network) may change for the purpose of placing an emergency call. Specifically, the WTRU may change its state to a limited substate when a user requests to place an emergency call and the WTRU is connected to a cell/PLMN that does not provide this service. This allows the WTRU to perform an emergency attach procedure which otherwise may not be done if the WTRU is not in a limited substate.

The WTRU may learn about support of IMS emergency calls from the broadcast control channel (BCCH). Upon performing registration to its selected PLMN, the WTRU may learn if the selected PLMN supports emergency calls. This is included in the NAS messages, e.g., attach or TAU accept (or any other message). The WTRU may save the information from both the BCCH and NAS messages.

Assuming an emergency call is requested by the user and the WTRU is in connected mode, the NAS, (knowing that its current cell/PLMN does not provide emergency calls), autonomously changes its EMM state and enters a limited substate, e.g., EMM-registered.limited-service. The WTRU may take other actions (e.g., saving its currently used contexts). The WTRU may also provide a new release cause to the RRC layer. The RRC layer may indicate a new release cause to the NAS after an autonomous release of the RRC connection is completed. The WTRU then continues with the emergency attach procedure as already known.

The WTRU may provide a new establishment or re-establishment cause when attempting to place an emergency call on a new cell. This may be used by the eNB to understand that the current WTRU is attempting an emergency call because its PLMN does not provide that service. Hence, the eNB may use this cause to route the WTRU's request to an appropriate core network that supports emergency calls.

In addition, in case of network sharing, the WTRU may add a short bitmap to the RRC connection request message. The bitmap may provide the eNB which PLMN(s) the WTRU was registered on when an emergency call attempt failed prior to this new selected cell. This indication from the WTRU may ease the MME selection for the eNB in case of network sharing.

The alternative described above applies to WTRUs in either connected or idle mode.

The WTRU may use a new attach type (e.g., “re-attach for emergency”) to indicate to the receiving MME node that this is a WTRU that was registered in another core network that does not provide emergency calls. The MME may use this indication to fetch the WTRU's context or any other required information if necessary.

If the eNB routes the emergency call to an MME that belongs to a PLMN that is different from the PLMN chosen by the WTRU, then there may be issues related to security as the PLMN ID is used as input to generate the master key KASME. Thus, the following alternatives may be used to resolve this issue.

The WTRU may be informed about the PLMN that is chosen before the derivation of the key. For example, the WTRU may be informed with RRC signaling, e.g., in the RRC connection setup by introducing a new IE, or a bitmap corresponding to the number of PLMNs in the shared network. A bit position that is set to one may indicate the PLMN that may be used by the WTRU as input to derive the key. The AS may forward the information to the NAS upon identification of the chosen PLMN ID.

The WTRU may be informed via NAS signaling, e.g. in the Authentication Request message. This may be achieved by introducing a new IE that holds the value of the chosen PLMN.

In any case, the WTRU may use the indicated PLMN as input to the key derivation function and may ignore the PLMN that it provided to the eNB during the RRC connection establishment procedure.

The security procedure may be skipped in cases where the eNB chooses a different PLMN/MME from what the WTRU has indicated in the RRC connection establishment.

The security procedure may be performed, but the null algorithm may be used for ciphering and integrity protection. As such, the WTRU and the MME may use dummy values (also applies to PLMN ID) in the derivation of the key.

Even though the eNB may choose a different PLMN from the WTRU, the eNB may indicate to the MME the choice that the WTRU has made as its PLMN. The MME may use this information to derive the same key as the WTRU which also uses its chosen PLMN. The MME may inform the home subscriber server (HSS) about this in order to use the same inputs to the key derivation.

The WTRU may be informed about the PLMN ID, or in other cases in which the WTRU's choice may be different from that of the eNB. The described alternatives may also apply to third generation (3G) and GERAN systems.

Information may be included in RRC messages during inter-system change from GERAN/UTRAN to E-UTRAN (or vice versa) regarding services, or particular identities that are needed for other procedures and general information that is useful for other procedures, that are supported/needed in the target system. The WTRU may use this signaled information to learn about service provision, feature support, or to derive certain parameters that are needed for other procedures (e.g., security, registration, updates).

In a shared network, the WTRU may be informed about the support of IMS emergency calls for every PLMN. For example, this functionality may be achieved by introducing an IMS emergency support indication bit for every PLMN that is included in the SIBs.

The SIBs of a cell/PLMN broadcasts information about the support of emergency calls (with IMS or any other protocol/solution) in other cells/PLMNs/networks. The WTRU then knows which cell/PLMN/network support emergency calls. Thus, in case its current network does not support emergency calls, it may quickly get emergency services when required because it knows what PLMN/network/cell supports this service (this also applies in scenarios where the network is not shared).

The WTRU may be informed about the support of emergency calls in the list of equivalent PLMNs that is provided to the WTRU in NAS messages, e.g., TAU or attach accept. Thus, for every PLMN in the list of equivalent PLMN list, the WTRU is provided with information about the support of emergency calls in that PLMN/network.

One way of achieving this, for example, is to provide a bitmap with enough bits that correspond to the list of equivalent PLMNs that is provided to the WTRU, where each bit, e.g., if set to one indicates that emergency calls are supported, otherwise they are not supported.

Alternatively, the WTRU may assume the following if no such indication is provided. The list of equivalent PLMNs support emergency calls, or the list of equivalent PLMNs does not support emergency calls and the WTRU may have to use other means to find out about service support within each PLMN.

The WTRU may inform any other lower or upper layer about any information that is interpreted regarding the equivalent list of PLMNs that might be included in the NAS messages.

The described alternatives apply to E-UTRAN and GERAN/UTRAN where similar messages are used instead, e.g., routing area update message in a 3G system.

Moreover, the described alternatives apply for services that are not limited to emergency services only, or cases that are not limited to a WTRU being on a PLMN/MME/network that does not support emergency services. Thus, the described alternatives apply to any other service type and system. The described alternatives may be used in any combination.

### The WTRU is in EMM-Registered.Limited-Service

A WTRU may be camping on a CSG for which the CSG ID is in the WTRU's allowed CSG list (or other lists that provide the allowed CSG IDs) but the subscription has expired in the network side and the WTRU is not aware of it. If a WTRU attempts to initiate a PS session (for non-emergency purposes), it sends a service request message to the MME. The MME may reject the request with a cause set to “not authorized for this CSG” for which the WTRU enters EMM-registered.limited-service. If the WTRU sees no other LTE cell and an emergency call is dialed, then the WTRU will attempt access on the CSG cell. In such as case:

The WTRU may send a service request message with establishment cause set to “emergency calls” during the RRC connection establishment.

The eNB may inform the MME about the cause being an emergency call. The MME may accept the request and (at least) set up radio and other bearers that are needed only for emergency calls, (i.e., no radio and S1 bearers (or other) will be set up for any other bearer that is considered to be active in the WTRU and/or the MME).

The WTRU and/or MME may deactivate the EPS context bearers for which no radio and S1 bearers were established during the request for emergency call.

The described alternative may be used in any combination. The MME may also process the service request procedure as usual, (i.e., ignoring the fact that the WTRU is in the limited sub-state only because the WTRU is requesting an emergency call).

The described alternatives apply to E-UTRAN and GERAN/UTRAN where similar messages are used instead, (e.g., a RAU message procedure in a 3G system).

Moreover, the described alternatives apply for services that are not limited to emergency services only, or cases that are not limited to a WTRU being on a PLMN/MME/network that does not support emergency services. The described alternatives apply to any other service type and system (also non-3GPP systems).

### Differentiating Emergency Calls

Depending on the mode of operation, a WTRU in E-UTRAN may use different establishment causes for every case of emergency calls. For example, a WTRU uses “CSFB Emergency calls” as establishment cause when it wants to place a CSFB request for mobile originated (MO) emergency CSFB, and “IMS Emergency calls” may be used whenever a request, an attach message or other, is for the requesting emergency calls with IMS. The eNB may then decide whether or not to route the NAS message to another PLMN/MME.

The eNB distinguishes the emergency calls with CSFB or IMS based on the WTRU identity that may be used in the RRC connection request message and may use this to decide on whether or not to route the NAS message to another PLMN/MME or to the PLMN/MME that may be chosen by the WTRU. For example, this may be performed by the WTRU using a serving-temporary mobile subscriber identity (S-TMSI) versus a random ID, or a new identity may be introduced with different length or preconfigured value to indicate specific scenarios or requests. The 3GPP standards body specifies that the eNB distinguishes limited mode WTRUs that may be accessing a PLMN/MME for IMS emergency calls with the random ID that is included in the RRC message. However, there is nothing specified that mandates the WTRU to include a random ID as its identity. Thus if an S-TMSI is included then the eNB may not be able to know that this request may be due to a source PLMN/MME having no IMS emergency call support.

The WTRU may provide an explicit indication of the type of emergency calls that it wants to perform, for example, by adding a new IE or bitmap in the RRC messages. One bit may be used to differentiate between IMS emergency calls and CSFB emergency calls. This bit can be included in RRCConnectionRequest or RRC connection setup complete message (or other).

The WTRU may provide an indication about its state and the eNB may be identified if the request is for an emergency with IMS vs CSFB or any other type of solution, for example, limited state. The WTRUs may only be provided with IMS emergency calls since CSFB requires successful registration. One way of doing so may be with the use one bit or an IE to indicate the state of the WTRU, for example, normal vs limited state.

One solution may be having the eNB verify the piggy backed NAS message to know the exact type of request and thus forward it to the right entity. This may be on a conditional basis only when the establishment cause is set to any value indication emergency calls. Thus, the eNB may have some NAS intelligence in order to successfully route the NAS signaling to the appropriate entity. These procedures may be used in any combination, and may apply to GERAN and UTRAN (3G) systems as well.

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

What is claimed is:

1. A method, implemented by a wireless transmit/receive unit (WTRU), for processing an emergency call, the method comprising:
receiving a system information (SI) broadcast including emergency services support information that conveys various emergency call network support levels and setup procedures; and
decoding the SI broadcast to retrieve system parameters used to process an emergency call.

2. The method of claim 1 wherein the SI broadcast includes a bitmap inserted in a plurality of SI blocks (SIBs), each bit in the bitmap having a value representing whether or not certain types of the emergency call setup procedures are supported.

3. The method of claim 1 wherein the SI broadcast includes at least one information element (IE) that indicates the various emergency call network support levels.

4. The method of claim 1 further comprising:
transmitting an emergency call random access preamble that conveys various emergency call support capabilities of the WTRU; and
transmitting a radio resource control (RRC) request message that requests the establishment of a connection for performing an emergency call.

5. The method of claim 4 further comprising:
wherein an initial transmit power level is increased by an offset value when the emergency call random access preamble is transmitted.

6. The method of claim 1 further comprising:
performing an attach procedure;
transmitting a tracking area update (TAU) request that conveys various preferences for emergency call establishment and various emergency call support capabilities of the WTRU; and
receiving a TAU accept message.

7. The method of claim 1 further comprising:
receiving a random access channel (RACH) response message;
performing a RACH procedure, wherein a timing advance (TA) is applied in the RACH response message after a delay of a predetermined number of subframes, on a condition that the RACH procedure is not for an emergency call, and reducing the delay on a condition that the RACH procedure is for an emergency call; and
transmitting a radio resource control (RRC) request message that requests the establishment of a connection for performing an emergency call.

8. The method of claim 1 further comprising:
monitoring the number of emergency attach attempts made for requesting an emergency call to be established; and
taking necessary action when the number of emergency attach attempts reaches a predetermined maximum number of attempts.

9. The method of claim 8 wherein the necessary action includes reselecting to a radio access technology (RAT) network that provides circuit switched (CS) services.

10. The method of claim 8 further comprising:
initiating a timer, wherein the necessary action is taken if the timer expires before the predetermined maximum number of emergency attach attempts is reached.

11. A method, implemented by a wireless transmit/receive unit (WTRU), for processing an emergency call, the method comprising:
transmitting, to a packet switched (PS) radio access technology (RAT) network, an extended service request message indicating circuit switched fallback (CSFB) for an emergency call during a PS session;
performing an inter-system change from the PS RAT network to a circuit switched (CS) RAT network without PS handover; and
initiating a CS emergency call via the CS RAT network.

12. The method of claim 11 wherein the PS session is suspended or terminated.

13. A wireless transmit/receive unit (WTRU) for processing an emergency call, the WTRU comprising:
a receiver configured to receive a system information (SI) broadcast including emergency services support information that conveys various emergency call network support levels and setup procedures; and
a processor configured to decode the SI broadcast to retrieve system parameters used to process an emergency call.

14. The WTRU of claim 13 wherein the SI broadcast includes a bitmap inserted in a plurality of SI blocks (SIBs), each bit in the bitmap having a value representing whether or not certain types of the emergency call setup procedures are supported.

15. The WTRU of claim 13 wherein the SI broadcast includes at least one information element (IE) that indicates the various emergency call network support levels.

16. The WTRU of claim 13 further comprising:
the processor configured to generate an emergency call random access preamble that conveys various emergency call support capabilities of the WTRU; and
a transmitter configured to transmit the emergency call random access preamble, and transmit a radio resource control (RRC) request message that requests the establishment of a connection for performing an emergency call.

17. The WTRU of claim 16 wherein an initial transmit power level is increased by an offset value when the emergency call random access preamble is transmitted.

18. The WTRU of claim 13 further comprising:
the processor configured to perform an attach procedure;
a transmitter configured to transmit a tracking area update (TAU) request that conveys various preferences for emergency call establishment and various emergency call support capabilities of the WTRU; and
the receiver configured to receive a TAU accept message.

19. The WTRU of claim 13 further comprising:
the receiver configured to receive a random access channel (RACH) response message;
the processor configured to perform a RACH procedure, wherein a timing advance (TA) is applied in the RACH response message after a delay of a predetermined number of subframes, on a condition that the RACH procedure is not for an emergency call, and reducing the delay on a condition that the RACH procedure is for an emergency call; and
a transmitter configured to transmit a radio resource control (RRC) request message that requests the establishment of a connection for performing an emergency call.

20. A wireless transmit/receive unit (WTRU) for processing an emergency call, the WTRU comprising:
a transmitter configured to transmit, to a packet switched (PS) radio access technology (RAT) network, an extended service request message indicating circuit switched fallback (CSFB) for an emergency call during a PS session; and
the processor configured to perform an inter-system change from the PS RAT network to a circuit switched (CS) RAT network without PS handover, and initiate CS emergency call via the CS RAT network.
